(19) United States
(12) Patent Application Publication
(10) Pub. No.: US 2014/0043123 A1
(43) Pub. Date: Feb. 13, 2014

(54) MAGNETIC CHUCK

(71) Applicants: Yong Goo Lee, Gyeonggi-do (KR); Jong Suk Lee, Gyeonggi-do (KR); Jong Min Lee, Gyeonggi-do (KR)

(72) Inventors: Yong Goo Lee, Gyeonggi-do (KR); Jong Suk Lee, Gyeonggi-do (KR); Jong Min Lee, Gyeonggi-do (KR)

(73) Assignee: JIN YOUNG PRECISION MACHINE CO., LTD., Gyeonggi-do (KR)

(21) Appl. No.: 14/112,551

(22) PCT Filed: Apr. 17, 2012
(86) PCT No.: PCT/KR12/02901

§ 371 Date: Oct. 18, 2013

(30) Foreign Application Priority Data
Apr. 21, 2011 (KR) 10-2011-0037438

(51) Int. Cl. H01F 7/02

(52) U.S. Cl. CPC H01F 7/02
USPC 335/285

(57) ABSTRACT

The present invention relates to a magnetic chuck. The present invention provides a magnetic chuck capable of attaching and processing a workpiece by magnetism, and the magnetic chuck comprises: a small-sized magnetic member which includes a magnetic substance having magnetic properties, and panel units that are respectively positioned on both sides of said magnetic substance through heat treatment and in which non-magnetic panels are inserted between a plurality of magnetic panels; a sidewall unit which has accommodation grooves by positioning respectively a first sidewall and a second sidewall on both sides of said small-sized magnetic member; coupling members which are coupled by penetrating said small-sized magnetic member and the sidewall unit; alnico magnets which are inserted into said accommodation grooves; coils which are inserted into said accommodation grooves, and enclose the alnico magnets; fillings which mutually couple said alnico magnets and said coils, and are filled in the accommodation grooves such that one side of the alnico magnets is exposed; and a first insulator which is equipped on one side of said first sidewall to allow magnetism, which flows into the first sidewall, to flow in another direction.

### CROSS-REFERENCE TO RELATED APPLICATION

This application claims the benefit of Korean Patent Application No. 10-2011-0037438, filed on Apr. 21, 2011 in the Korean Intellectual Property Office, the disclosure of which is incorporated herein by reference.

### TECHNICAL FIELD

The present invention relates to a magnetic chuck. More particularly, the present invention relates to a magnetic chuck that can perform a horizontal processing and a vertical processing by attaching a workpiece to a front surface of a magnetic chuck using in a machine tool and that can form one side corner of the magnetic chuck in an inclined surface inclined by a constant angle or that can process a workpiece in a predetermined angle by fixing a jig in which an inclined surface is formed.

### BACKGROUND ART

In general, a chuck of a machine tool is an accessory device installed in a table of the machine tool to fix a workpiece and includes a common chuck, an air chuck, and a collet chuck, and there is a magnetic chuck that is installed in a table using a magnet and that can attach and process a workpiece.

In the magnetic chuck, a magnetic chuck that alternately couples a magnetic panel and a non-magnetic panel in opposite is developed and used.

FIG. 1 is a perspective view illustrating a conventional magnetic chuck.

As shown in FIG. 1, the conventional magnetic chuck includes a panel unit 128 in which a non-magnetic panel 126 is inserted between a plurality of magnetic panels 124, a top plate 120 including a fastening panel 122 provided at both sides of the panel unit 128, a main body 140 that couples to the top plate 120 and that has a partition 144 to be formed with a plurality of receiving grooves 142, an Alnico magnet 130 inserted into each receiving groove 142, a coil 150 that encloses the Alnico magnet 130 inserted into the receiving groove 142, and a filling material 160 that binds the Alnico magnet 130 and the coil 150 and that is filled in the receiving groove 142.

Because the main body 140 of such a magnetic chuck forms the partition 144 using a milling machine and forms the receiving groove 142 by cutting in a predetermined size and depth, there was a problem that much time is consumed for a cutting processing and that a material is inefficiently wasted due to a chip generating upon processing.

Further, by flatly cutting and grinding a lower portion of the top plate 120 and an upper portion of the main body 140 in which the filling material 160 is filled in the receiving groove 142, when coupling the main body 140 and the top plate 120, a conventional magnetic chuck may be produced.

In this way, because the conventional magnetic chuck is formed with a plurality of parts, there was a problem that the number of processing of coupling the plurality of parts is many and that a production process is complicated and that the magnetic chuck is produced for a long time and that a product cost thus increases.

Further, because a workpiece may be attached to only an upper portion of the top plate 120, a processing other than a horizontal processing was limited, and in a process of attaching and detaching the workpiece, damage such as a scar has occurred in an upper portion of the top plate 120, and a processing of grinding an upper portion of the top plate 120 is additionally necessary according to whether the top plate 120 is damaged, and particularly, because a thickness that can perform a grinding processing is small, there was a problem that a use period of the top plate 120 is short.

Further, in a process of moving a position of the magnetic chuck by pulling and pushing in a table and the bottom, there was a problem that a commercial value of the magnetic chuck is deteriorated due to damage that may occur in a lower portion of the main body 140.

### TECHNICAL PROBLEM

The present invention has been made in view of the above problems, and provides a magnetic chuck that reduces the number of cutting and grinding processing while manufacturing the magnetic chuck and that reduces a production cost and a production time by simplifying assembly of parts.

The present invention further provides a magnetic chuck that can be produced in a small size or a large size to easily use the magnetic chuck, as needed and that can attach a workpiece to a front surface of the magnetic chuck to perform a horizontal processing and a vertical processing and in which one side corner of the magnetic chuck is formed in an inclined surface inclined by a constant angle or that can process a workpiece in a predetermined angle by attaching a jig in which an inclined surface is formed.

The present invention further provides a magnetic chuck that can prevent damage generating in the magnetic chuck and that can maintain a commercial value and precision and that can use a long term when attaching and detaching a workpiece by performing a heat treatment of one side of the magnetic chuck and when pulling and pushing the magnetic chuck so as to move a position thereof in a table and the bottom by providing a steel plate to the other side thereof.

### TECHNICAL SOLUTION

In accordance with an aspect of the present invention, there is a magnetic chuck that can attach and process a workpiece by a magnetic force including: a magnetic substance having magnetism; a small-sized magnetic member including panel units each heat treating and provided at both sides of the magnet substance and in which a non-magnetic panel is inserted between a plurality of magnetic panels; a sidewall unit in which a first sidewall and a second sidewall are provided at both sides, respectively of the small-sized magnetic member to form a receiving groove; a coupling member that penetrates and couples the small-sized magnetic member and the sidewall unit; an Alnico magnet inserted into the receiving groove; a coil that encloses the Alnico magnet; a filling material that binds the Alnico magnet and the coil and that is filled in the receiving groove so that one side surface of the Alnico magnet may be exposed; and a first insulator that enables a magnetic force flowing to the first sidewall to flow to another direction at one side of the first sidewall.

Preferably, the magnetic chuck further includes a heat-treated scar prevention plate that can prevent a scar at one side surface of the Alnico magnet.

Preferably, the magnetic substance has a magnetic protruded portion having both sides vertically protruded, and the panel unit has a panel protruded portion having both sides vertically protruded and thus the magnetic substance and the panel unit are formed in a ‘ [symbol] ’ shape.

Preferably, surfaces of one side surface of the magnetic substance, the panel unit, and the sidewall unit are heat-treated to prevent a scar from occurring when the workpiece is attached.

Preferably, the magnetic chuck further includes an inserting portion that inserts a fixed piece by cutting out a portion of one of a magnetic substance or a non-magnetic substance at one side of the panel unit.

### ADVANTAGEOUS EFFECTS

According to the present invention, by reducing a process and the number of cutting and grinding processing while manufacturing a magnetic chuck and by simplifying assembly of parts, a production cost and a production time can be reduced.

Further, according to the present invention, by providing a magnetic chuck that can be produced in a small size or a large size, the magnetic chuck can be easily used, as needed, and because a workpiece can be attached to a front surface of the magnetic chuck, a horizontal processing and a vertical processing of the magnetic chuck is available, and one side corner of the magnetic chuck is formed in an inclined surface inclined by a constant angle or a workpiece can be processed in a predetermined angle by attaching a jig in which an inclined surface is formed.

Further, according to the present invention, when attaching and detaching a workpiece by performing a heat treatment at one side of the magnetic chuck and when pulling and pushing to move a position of the magnetic chuck in a table and the bottom by providing a steel plate to the other side thereof, damage is prevented from occurring in the magnetic chuck, and a commercial value and precision are maintained, and the magnetic chuck can be used for a long term.

### BRIEF DESCRIPTION OF DRAWINGS

FIG. 1 is a perspective view illustrating a conventional magnetic chuck.

FIGS. 2 to 6 are perspective views illustrating a magnetic chuck according to a first exemplary embodiment of the present invention.

FIG. 7 is a front cross-sectional view illustrating a magnetic chuck according to a first exemplary embodiment of the present invention.

FIGS. 8 to 12 are side cross-sectional views illustrating a use example of a magnetic chuck according to a first exemplary embodiment of the present invention.

FIGS. 13 to 16 are perspective views illustrating a magnetic chuck according to a second exemplary embodiment of the present invention.

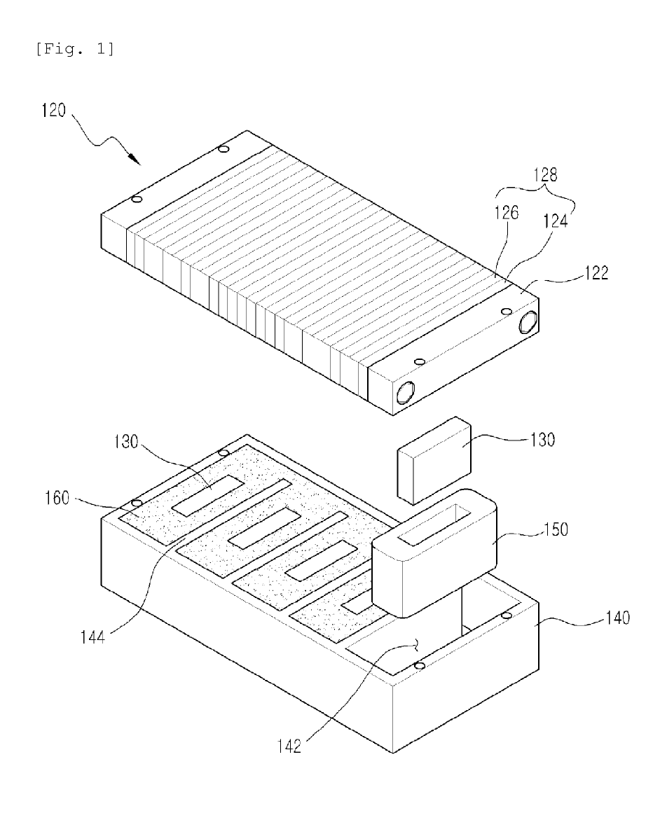

### BEST MODES FOR CARRYING OUT THE INVENTION

The present invention provides a magnetic chuck that can attach and process a workpiece by a magnetic force including: a magnetic substance having magnetism; a small-sized magnetic member including panel units each heating treating and provided at both sides of the magnet substance and in which a non-magnetic panel is inserted between a plurality of magnetic panels; a sidewall unit in which a first sidewall and a second sidewall are provided at both sides, respectively of the small-sized magnetic member to form a receiving groove; a coupling member that penetrates and couples the small-sized magnetic member and the sidewall unit; an Alnico magnet inserted into the receiving groove; a coil that encloses the Alnico magnet; a filling material that binds the Alnico magnet and the coil and that is filled in the receiving groove so that one side surface of the Alnico magnet may be exposed; and a first insulator that enables a magnetic force flowing to the first sidewall to flow to another direction at one side of the first sidewall.

### Mode for Carrying Out the Invention

Hereinafter, an exemplary embodiment of the present invention will be described in detail with reference to the accompanying drawings. Like reference numerals designate like elements throughout the specification. Further, detailed descriptions of well-known functions and structures incorporated herein may be omitted to avoid obscuring the subject matter of this document.

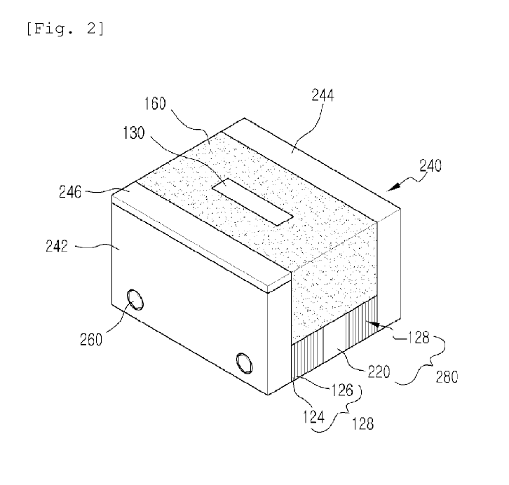

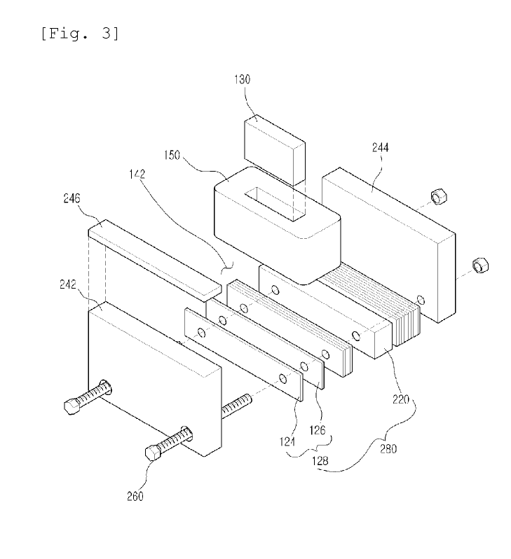

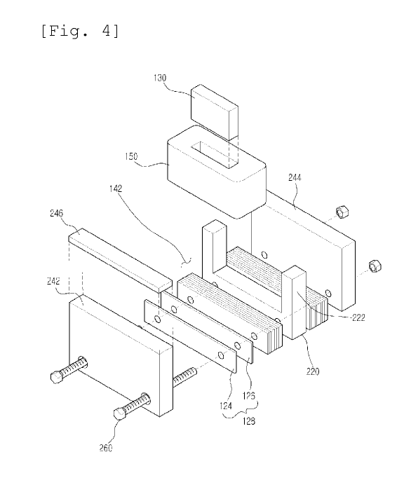

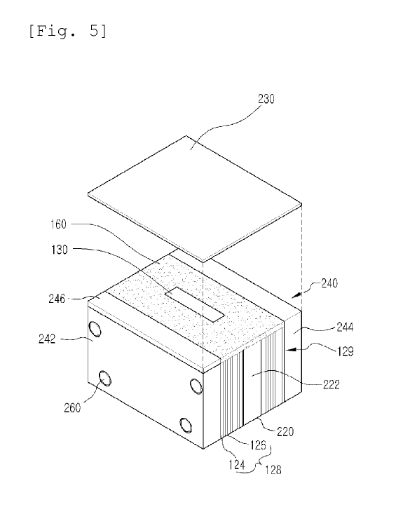

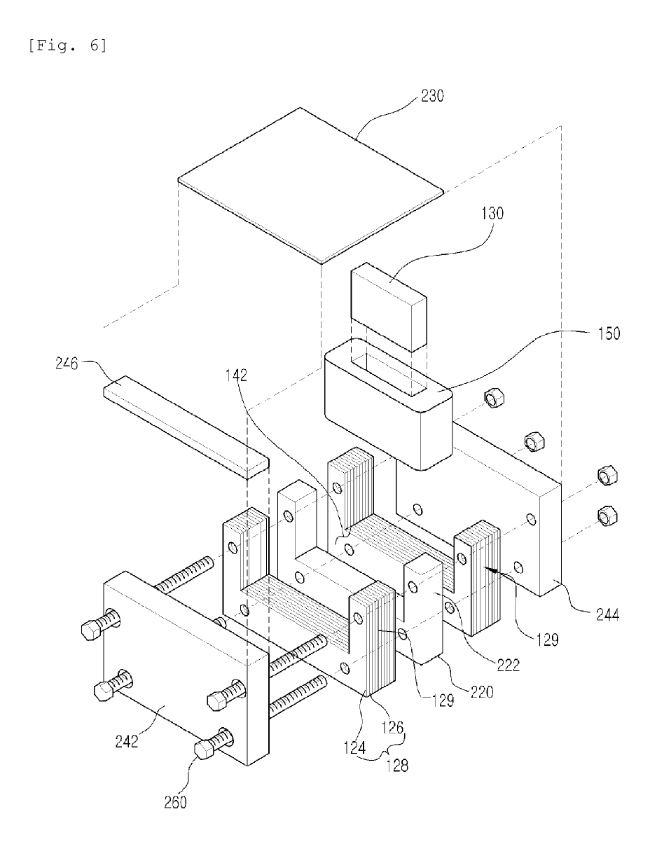

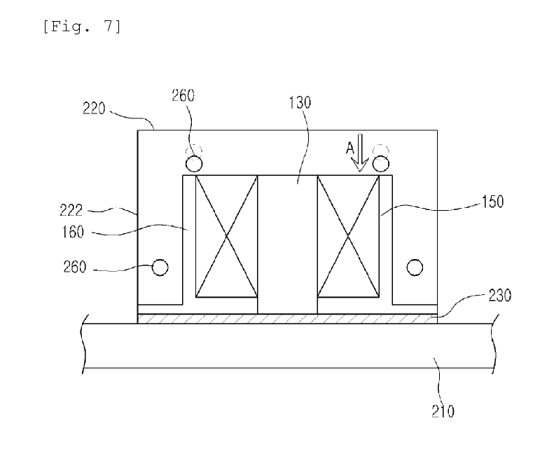

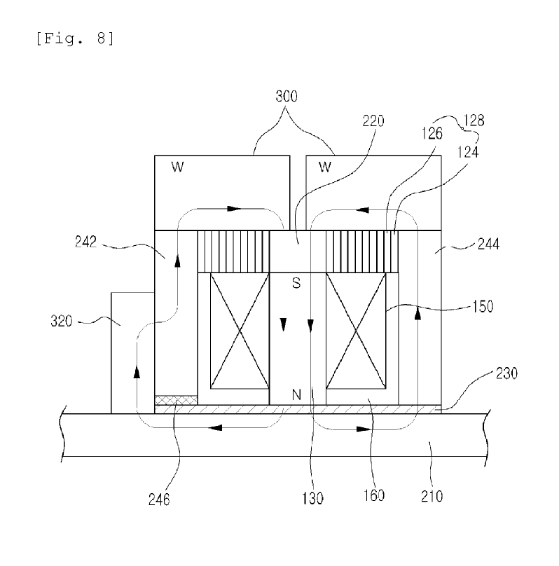

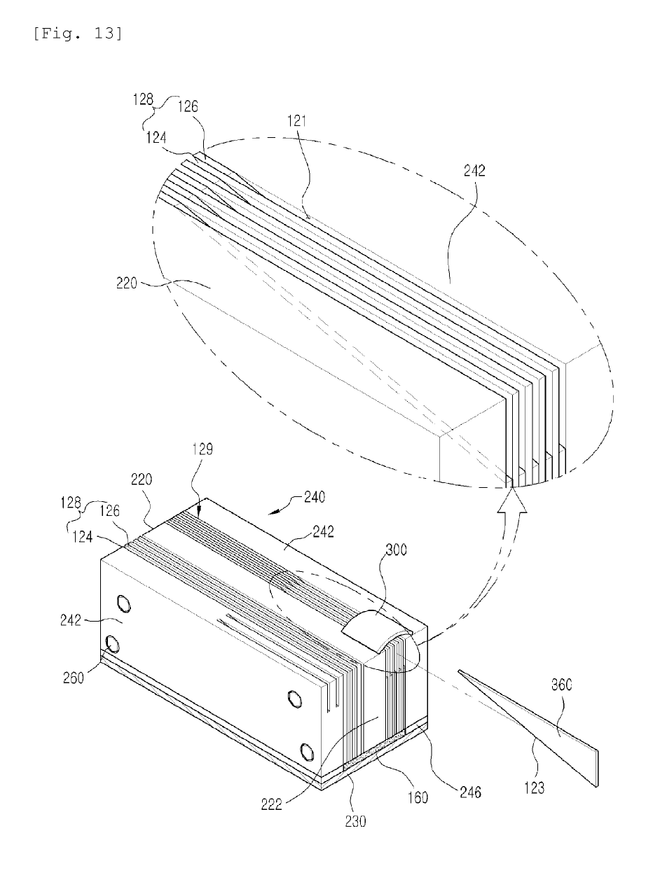

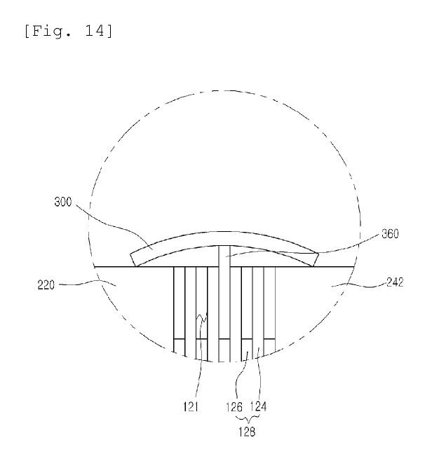

FIGS. 2 to 6 are perspective views illustrating a magnetic chuck according to a first exemplary embodiment of the present invention, and FIG. 7 is a front cross-sectional view illustrating a magnetic chuck according to a first exemplary embodiment of the present invention. FIGS. 8 to 12 are side cross-sectional views illustrating a use example of a magnetic chuck according to a first exemplary embodiment of the present invention, and FIGS. 13 to 16 are perspective views illustrating a magnetic chuck according to a second exemplary embodiment of the present invention.

As shown in FIGS. 2 to 12, the magnetic chuck according to a first exemplary embodiment of the present invention includes a magnetic substance 220 having magnetism, small-sized magnetic members 280 including the panel unit 128 each provided at both sides of the magnetic substance 220 and in which a non-magnetic panel 126 is inserted between a plurality of magnetic panels 124, a sidewall unit 240 in which a receiving groove 142 is formed between a first sidewall 242 and a second sidewall 244 each provided at both sides, respectively of the small-sized magnetic member 280, a coupling member 260 that penetrates and couples the small-sized magnetic member 280 and the sidewall unit 240, an Alnico magnet 130 that is inserted into the receiving groove 142, a coil 150 that encloses the Alnico magnet 130, a filling material 160 that binds the Alnico magnet 130 and the coil 150 and that is filled in the receiving groove 142 so that one side surface of the Alnico magnet 130 is exposed, and a first insulator 246 that is provided at one side of the first sidewall 242 so that a magnetic force flowing to the first sidewall 242 may flow in another direction.

After a workpiece 300 is disposed adjacent to an outer side surface of the panel unit 128, the magnetic substance 220, and the first sidewall 242 of such a magnetic chuck, by applying power, when the Alnico magnet 130 is magnetized, a line of magnetic force that flows the workpiece 300 is formed in the magnetic chuck and thus the workpiece 300 is attached to the panel unit 128, the magnetic substance 220, and the first sidewall 242.

In this case, by applying power to the Alnico magnet 130, the Alnico magnet 130 may be used as a permanent magnet and thus even if power is short-circuited, a line of magnetic force is continuously formed and thus power to be supplied thereto can be saved.

Further, in order to prevent a scar occurring when attaching the workpiece 300 to an outer side surface of the panel unit 128, the magnetic substance 220, and the first sidewall 242 or when detaching the workpiece 300 from an outer side surface of the panel unit 128, the magnetic substance 220, and the first sidewall 242 and when processing the workpiece 300, a surface of the panel unit 128, the magnetic substance 220, and the sidewall unit 240 is heat-treated, and because a line of magnetic force may be weakened due to a surface heat treatment, it is preferable that a surface of only about 2-3 mm is heat treated from an outer side surface to the inside of the panel unit 128, the magnetic substance 220, and the first sidewall 242 and the present invention is not limited thereto.

Further, the coupling member 260 is formed with a stainless bolt and nut, prevents a foreign substance from being injected between the small-sized magnetic member 280 and the sidewall unit 240, penetrates the small-sized magnetic member 280, the sidewall unit 240 and the first sidewall 242 so as to prevent the small-sized magnetic member 280 and the sidewall unit 240 from being separated, and couples the small-sized magnetic member 280, the sidewall unit 240 and the first sidewall 242 by applying a predetermined pressure.

When the workpiece 300 or a first jig 320 is attached to the outside of the first sidewall 242, the first insulator 246 of the magnetic chuck performs a function of changing a direction of a magnetic force flowing to the workpiece 300 or the first jig 320.

That is, when performing a vertical processing, the workpiece 300 is attached to the outside of the first sidewall 242 to be thus easily processed and thus the first insulator 246 may be provided in both the first sidewall 242 and the second sidewall 244, but the present invention is not limited thereto.

When a position of the magnetic chuck is changed by pushing or pulling in a table 210, a scar prevention plate 230 in which a heat treatment is performed to prevent a scar occurring in a lower portion of the magnetic chuck contacting with the table 210, i.e., one side surface of the Alnico magnet 130 and the filling material 160 is additionally provided. Further, by providing the scar prevention plate 230, when moving the magnetic chuck to another location, the magnetic chuck can be easily moved by pushing or pulling at the bottom, and a commercial value of the magnetic chuck can be maintained.

The magnetic substance 220 of the magnetic chuck is formed in a bar shape, and as both sides thereof are vertically protruded, a magnetic protruded portion 222 may be formed, and the workpiece 300 may be attached to a side surface of the magnetic protruded portion 222. Further, the panel unit 128 is formed in a bar shape, and both sides thereof are vertically protruded to form the panel protruded portion 129.

That is, both sides of the magnetic substance 220 and the panel unit 128 are protruded in a ‘ [symbol] ’ shape and thus the workpiece 300 can be more securely attached to a side surface of the magnetic protruded portion 222, a panel protruded portion 129, and the sidewall unit 240.

Further, as shown in FIG. 7, when the magnetic substance 220 and the panel unit 128 are formed in a ‘ [symbol] ’ shape, the coupling member 260 that penetrates an upper portion of the magnetic chuck may be penetrated by moving to the inside of the magnetic chuck, i.e., in an ‘A’ direction. In this case, when a scar occurs in a process of attaching the workpiece 300 to the panel unit 128 and detaching the workpiece 300 from the panel unit 128, in order to remove the scar, a thickness that can perform a grinding processing at an upper portion of the magnetic chuck increases and thus the magnetic chuck can be used for a long term.

A major manufacturing process of such a magnetic chuck will be described.

By positioning the panel unit 128 formed with the magnetic panel 124 and the non-magnetic panel 126 at both sides of a plurality of magnetic substances 220, a small-sized magnetic member 280 is produced, and by providing the sidewall unit 240 at both sides of the small-sized magnetic member 280, the sidewall unit 240 at both sides of the small-sized magnetic member 280 are coupled with a coupling member that penetrates the small-sized magnetic member 280 and the sidewall unit 240. Thereafter, after inserting the Alnico magnet 130 and the coil 150 into the receiving groove 142 and filling and curing the filling material 160 so that one side surface of the Alnico magnet 130 is exposed, by attaching and coupling the scar prevention plate 230 to exposed one side surface of the Alnico magnet 130, a production process of the magnetic chuck is finished.

That is, in a process of manufacturing the magnetic chuck, a processing and a process are simple, and the number of parts is small and thus a production time can be shortened, and because a weight of the magnetic chuck is light, the magnetic chuck can be easily moved and a production cost can be saved.

Here, the filling material 160 is made of a non-magnetic resin, and after the filling material 160 is filled in the receiving groove 142, the filling material 160 may be cured so that a hole does not occur in a vacuum chamber, and by performing a waterproofing processing of a coil, the filling material 160 is a material that insulates the coil.

Next, a use example according to a first exemplary embodiment of the magnetic chuck will be described.

As shown in FIG. 8, in a state in which the magnetic chuck is positioned at the table 210, after disposing the workpiece 300 to be adjacent to an upper portion of the magnetic chuck, by applying power to the coil 150 of the magnetic chuck, the Alnico magnet 130 is magnetized.

In this case, at the left side of the magnetic chuck having the first insulator 246 between the first sidewall 242 and the scar prevention plate 230, by providing the first jig 320 in a sidewall of the first sidewall 242, a line of magnetic force flows to the Alnico magnet 130→the scar prevention plate 230→the table 210→the first jig 320→the first sidewall 242→the workpiece 300→the magnetic substance 220→the Alnico magnet 130.

That is, by enabling a magnetic force line to flow to the first jig 320, the first insulator 246 enables the workpiece 300 attached to an upper portion of the magnetic chuck to be more securely attached to an upper portion of the magnetic chuck.

Further, at the right side of the magnetic chuck, a line of magnetic force flowing to the Alnico magnet 130→the scar prevention plate 230→the table 210→the scar prevention plate 230→the second sidewall 244→the workpiece 300→the magnetic substance 220→the Alnico magnet 130 is formed, and the workpiece 300 is attached to an upper portion of the magnetic chuck and thus the workpiece 300 may be horizontally processed.

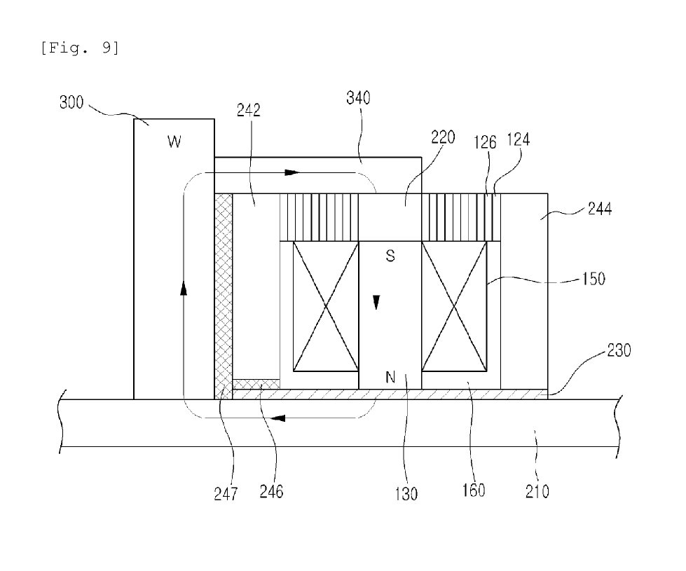

However, as shown in FIG. 9, as a second insulator 247 is provided between the workpiece 300 and a first sidewall 242 and a second jig 340 is provided to an upper portion of the magnetic chuck, a line of magnetic force flowing to the magnetic chuck is formed with the Alnico magnet 130→the scar prevention plate 230→the table 210→the workpiece 300→the second jig 340→the magnetic substance 220→the Alnico magnet 130.

Here, the second insulator 247 guides a line of magnetic force to flow to the second jig 340, and as the line of magnetic force flows through the second jig 340, the workpiece 300 is more securely attached and thus a vertical processing can be performed.

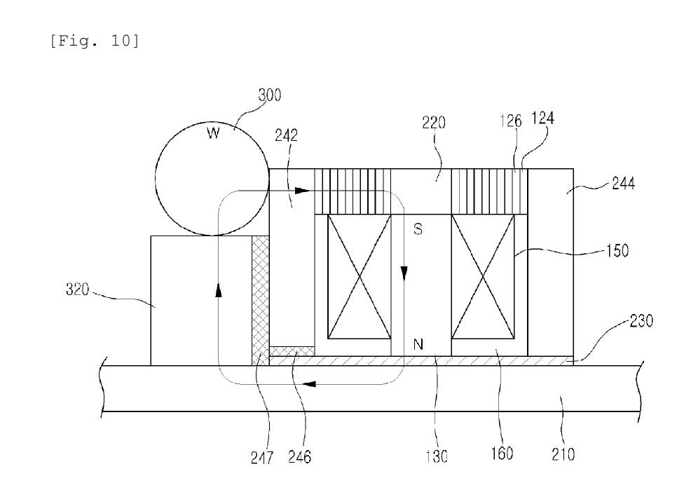

Similarly, referring to FIG. 10, because the workpiece 300 such as a round bar is attached by a line contact, by enabling the workpiece 300 to be attached to the first jig 320 and the first sidewall 242, after the workpiece 300 is strongly attached to the magnetic chuck, the workpiece 300 can be easily processed.

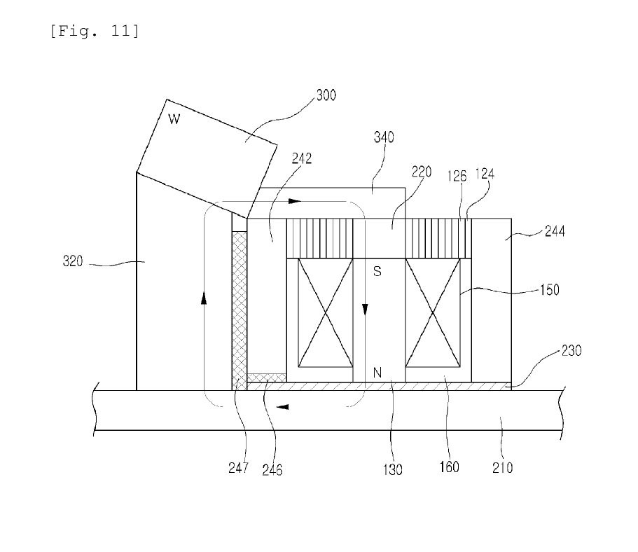

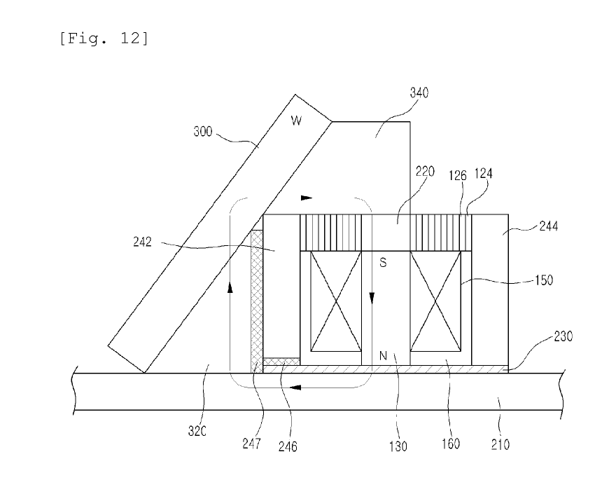

Further, as shown in FIGS. 11 and 12, when the workpiece 300 is inclined by a predetermined angle and is attached to the magnetic chuck, the workpiece 300 is attached by a surface contact to be not separated from the magnetic chuck, and the first jig 320 and the second jig 340 are formed in a predetermined angle to perform an angle processing to be attached to a side surface and an upper side, respectively, of the magnetic chuck.

Here, in the magnetic chuck, a line of magnetic force flowing to the Alnico magnet 130→the scar prevention plate 230→a table 250→the first jig 320→the workpiece 300→the second jig 340→the magnetic substance 220→the Alnico magnet 130 is formed.

As shown in FIGS. 13 to 16, at one side of the panel unit 128, a portion of one of a magnetic substance 124 or a non-magnetic substance 126 is cut out, and an inserting portion 121 that inserts a fixed piece 360 that supports a lower side surface of the curved workpiece 300 is formed.

In the workpiece 300, a curved bending phenomenon occurs by a heat generating upon processing to have a thin thickness, and for a grinding processing of the workpiece 300, when the workpiece 300 is attached to the magnetic chuck, the workpiece 300 is flatly spread and attached by a magnetic force while being attached to the magnetic chuck, and thus in order to attach the workpiece 300 while maintaining a bending level of the workpiece 300, the fixed piece 360 that supports a curved point of the workpiece 300 is inserted into an inserting portion 121 to support the workpiece 300 and thus a processing of the curved workpiece 300 can be smoothly performed.

Further, because a height in which the fixed piece 360 inserted into the inserting portion 121 formed by obliquely cutting out one of the magnetic substance 124 and the non-magnetic substance 126 is protruded according to a tilt is differently set, a grinding processing can be performed to correspond to a bending level of the workpiece 300.

In this case, at a cutout surface of the inserting portion 121 and a lower side surface of the fixed piece 360 rubbing with the cutout surface, it is preferable that an inclined slope 123 is formed to enable the fixed piece 360 to be stably inserted into the inserting portion 121, but the present invention is not limited thereto.

Further, the inserting portion 121 to which the fixed piece 360 is inserted may be formed even in the sidewall unit 240 and enables a plurality of fixed pieces 360 to be inserted for processing of the workpiece 300 forming bending portions of various forms and can simultaneously remove various foreign substances such as dust penetrating between the workpiece 300 and the magnetic chuck and prevent penetration thereof.

In this way, a magnetic chuck according to a first exemplary embodiment of the present invention is a small-sized magnetic member chuck, and a magnetic chuck according to a second exemplary embodiment of the present invention to be described later is a large-sized magnetic member chuck that can attach and use a workpiece having a wide attaching area and a jig by connecting a plurality of small-sized magnetic members in parallel.

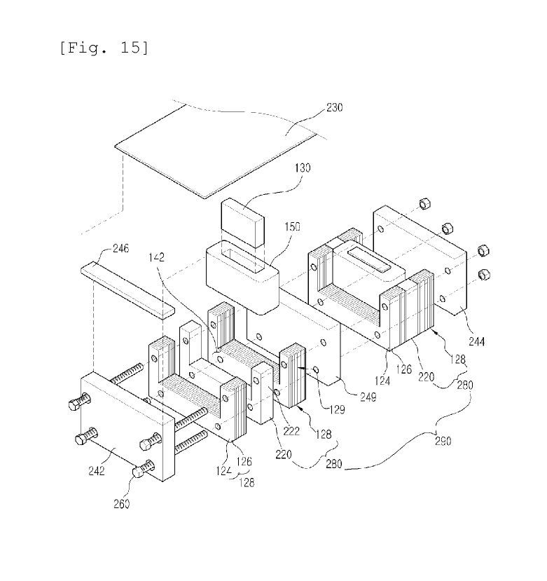

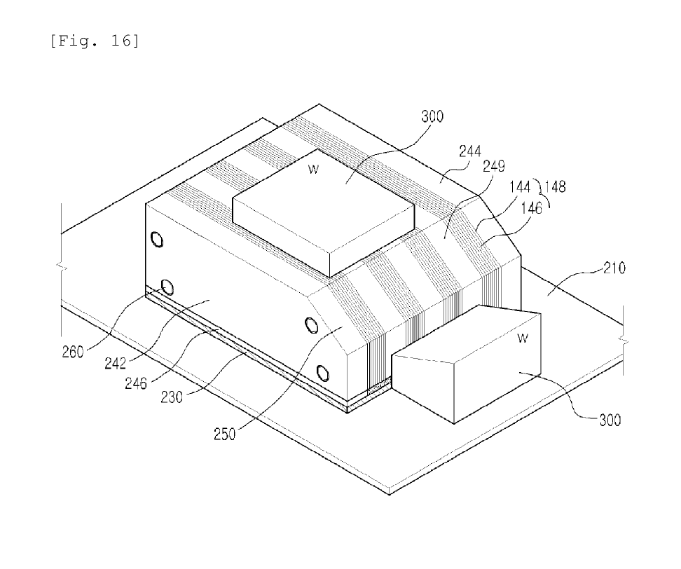

As shown in FIGS. 15 and 16, a magnetic chuck according to a second exemplary embodiment of the present invention includes a magnetic substance 220 having magnetism and in which a magnetic protruded portion 222 is formed so that both sides are vertically protruded to be a ‘ [symbol] ’ shape, a small-sized magnetic member 280 heat treated and provided at both sides of the magnetic substance 220 and in which the non-magnetic panel 126 is inserted between a plurality of magnetic panels 124 and including the panel unit 128 in which the panel protruded portion 129 is formed so that both sides of the magnetic panel 124 and the non-magnetic panel 126 are vertically protruded to be a ‘ [symbol] ’ shape, a large-sized magnetic member 290 in which a separation wall 246 is inserted between a plurality of small-sized magnetic members 280, as the plurality of small-sized magnetic members 280 are provided, a sidewall unit 240 having the receiving groove 142, as the first sidewall 242 and the second sidewall 244 are provided at both sides, respectively of the large-sized magnetic member 290, a coupling member 260 that penetrates and couples the large-sized magnetic member 290 and the sidewall unit 240, an Alnico magnet 130 inserted into the receiving groove 142, and a coil 150 that encloses the Alnico magnet 130, and a filling material 160 that binds the Alnico magnet 130 and the coil 150 and that is filled in the receiving groove 142 so that one side surface of the Alnico magnet 130 is exposed, and a first insulator 246 that enables a magnetic force flowing to the first sidewall 242 to flow to another direction at one side of the first sidewall 242.

Because such a magnetic chuck is formed with a plurality of small-sized magnetic members 280, the magnetic chuck is heavy and thus it is difficult for a user to carry the magnetic chuck. Therefore, the heat-treated scar prevention plate 230 that covers a low portion of the magnetic chuck, i.e., one side surface in which the Alnico magnet 130 is exposed is provided so that a position movement of the magnetic chuck can be easily performed by putting in the table 210 or a floor and by pushing or pulling. The scar prevention plate 230 can prevent a scar that may occur when pushing or pulling the magnetic chuck and maintain a commercial value of the magnetic chuck.

In order to process the workpiece 300 in a predetermined angle, an inclined surface 250 inclined in a constant angle is formed at a corner formed as the panel unit 128, the sidewall unit 240, and the separation wall 246 of the magnetic chuck are coupled, and at another corner of the inclined surface 250, an inclined surface may be formed in another angle.

Further, by attaching the workpiece 300 to the inclined surface 250 without using the first jig 320 or the second jig 340 inclined in a constant angle, an angle processing can be easily performed, and by attaching the workpiece 300 to the magnetic chuck, a horizontal processing and a vertical processing can be easily performed.

Particularly, when attaching the workpiece 300 to the magnetic chuck and when processing the attached workpiece 300, a surface of a magnetic substance, a panel unit, a separation wall, and a sidewall unit is heat-treated to prevent a scar from occurring at one side surface of the magnetic substance, the panel unit, the separation wall, and the sidewall unit.

Further, when flatly grinding the thin and curvedly bent workpiece 300, by inserting the fixed piece 360 into the inserting portion 121 that is formed by cutting out a portion of one of a magnetic substance and a non-magnetic substance at one side of a panel unit, a bending level of the workpiece 300 is maintained, and the workpiece 300 can be easily processed.

Further, after replacing the Alnico magnet 130 of constituent elements of the magnetic chuck according to the present invention with the magnetic substance 220, when manufacturing the magnetic chuck and continuing to apply power, a first exemplary embodiment and a second exemplary embodiment according to the present invention can be equally used.

### INDUSTRIAL APPLICABILITY

According to the present invention, by reducing processes and the processing number of a cutting and grinding processing while manufacturing the magnetic chuck and by simplifying assembly of parts, a production cost and a production time can be reduced.

1. A magnetic chuck that can attach and process a workpiece by a magnetic force, comprising:
a magnetic substance having magnetism;
a small-sized magnetic member comprising panel units each provided at both sides of the magnet material and in which a non-magnetic panel is inserted between a plurality of magnetic panels;
a sidewall unit in which a first sidewall and a second sidewall are provided at both sides of the small-sized magnetic member to form a receiving groove;
a coupling member that penetrates and couples the small-sized magnetic member and the sidewall unit;
an Alnico magnet inserted into the receiving groove;
a coil that encloses the Alnico magnet;
a filling material that binds the Alnico magnet and the coil and that is filled in the receiving groove so that one side surface of the Alnico magnet may be exposed; and
a first insulator that enables a magnetic force flowing to the first sidewall to flow to another direction at one side of the first sidewall.

2. The magnetic chuck of claim 1, further comprising a heat-treated scar prevention plate that can prevent a scar at one side surface of the Alnico magnet.

3. The magnetic chuck of claim 1, wherein the magnetic substance has a magnetic protruded portion having both sides vertically protruded, and the panel unit has a panel protruded portion having both sides vertically protruded and thus the magnetic substance and the panel unit are formed in a ‘ [symbol] ’ shape.

4. The magnetic chuck of claim 1, wherein surfaces of one side surface of the magnetic substance, the panel unit, and the sidewall unit are heat-treated to prevent a scar from occurring when the workpiece is attached.

5. The magnetic chuck of claim 1, further comprising an inserting portion that inserts a fixed piece by cutting out a portion of one of a magnetic substance or a non-magnetic substance at one side of the panel unit.

6. A magnetic chuck that can attach and process a workpiece by a magnetic force, comprising:
a magnetic substance having magnetism and in which a magnetic protruded portion is formed so that both sides thereof are vertically protruded to be a ‘ [symbol] ’ shape;
a small-sized magnetic member comprising a panel unit each provided at both sides of the magnetic substance and in which a non-magnetic panel is inserted between a plurality of magnetic panels and in which a panel protruded portion is formed so that both sides of the magnetic panel and the non-magnetic panel are vertically protruded to be a ‘ [symbol] ’ shape;
a large-sized magnetic member in which a plurality of small-sized magnetic member are provided in parallel to be formed by inserting a separation wall between the plurality of small-sized magnetic members;
a sidewall unit in which a first sidewall and a second sidewall are provided at both sides, respectively of the large-sized magnetic member to form a receiving groove;
a coupling member that penetrates and couples the large-sized magnetic member and the sidewall unit;
an Alnico magnet inserted into the receiving groove;
a coil that encloses the Alnico magnet;
a filling material that binds the Alnico magnet and the coil and that is filled in the receiving groove so that one side surface of the Alnico magnet may be exposed; and
a first insulator that enables a magnetic force flowing to the first sidewall to flow to another direction at one side of the first sidewall.

7. The magnetic chuck of claim 6, further comprising a heat-treated scar prevention plate that can prevent a scar from occurring at one side surface of the Alnico magnet.

8. The magnetic chuck of claim 6, wherein an inclined surface inclined in a constant angle is formed at one side corner of the magnetic chuck to process the workpiece in an angle.

9. The magnetic chuck of claim 6, wherein surfaces of one side surface of the magnetic substance, the panel unit, the separation wall, and the sidewall unit are heat-treated to prevent a scar from occurring when the workpiece is attached.

10. The magnetic chuck of claim 6, further comprising an inserting portion that inserts a fixed piece by cutting out a portion of one of a magnetic substance or a non-magnetic substance at one side of the panel unit.
